(19) United States
(12) Patent Application Publication
(10) Pub. No.: US 2007/0082820 A1
(43) Pub. Date: Apr. 12, 2007

(54) Composition and Method for Treating Plant Fungal Disease

(76) Inventors: Fred Busch, Clementon, NJ (US); Steve R. Burwell, Humacao, PR (US)

Correspondence Address: NEEDLE & ROSENBERG, P.C., SUITE 1000, 999 PEACHTREE STREET, ATLANTA, GA, 30309-3915, US

(21) Appl. No.: 10/537,141

(22) PCT Filed: Dec. 2, 2003
(86) PCT No.: PCT/US03/38118

§ 371 Date: Nov. 13, 2006

Related U.S. Application Data
(60) Provisional application No. 60/430,094, filed on Dec. 2, 2002.

(51) Int. Cl. A01N 43/34; A01N 43/66; A01N 43/40; A01N 33/14

(52) U.S. Cl. 504/155; 514/358; 514/241; 514/612

(57) ABSTRACT

The invention is directed to fungicide compositions adapted for preventing or inhibiting the witches'0 broom disorder. In one embodiment, the composition contains chlorothalonil, trichloromelamine, urea and water. The composition can be sprayed to the afflicted portions of the plant (i.e., the brooms) to eradicate or inhibit the growth of the disease.

This application claims the filing date benefit of the provisional application No. 60/430,094 filed Dec. 2, 2002; the provisional application is also incorporated herein in its entirety.

### BACKGROUND OF THE INVENTION

Witches' broom (Crinipellis perniciosa) is a symptom in woody plants where many twigs are densely clustered together to create a mass of twigs resembling a broom. Witches' broom can develop on many types of plants and trees and is caused by various microorganisms, fingi or insects. A particular strand of witches' brooms which is caused by fungi can be found on cherry, blackberry and cocoa trees. Honeysuckle witches' broom is believed to be caused by an aphid.

Whatever the cause, witches' broom is considered to be a serious disease affecting crops in general and cocoa trees in Latin America. Witches' broom is believed to be indigenous to the Amazons and is now present in most of the cocoa growing regions in South America and the Caribbean islands. For example, witches' broom has been reported in Bolivia, Brazil, Colombia, Ecuador, Grenada, Guyana, Panama (on the South American side of the canal), Peru, St. Vincent, Surinam, Tobago, Trinidad, and Venezuela. Witches' broom was detected for the first time in Bahia, Brazil in 1989. It invaded the major growing areas of Brazil and ravaged production to the extend of 60% yield reduction during a four year period.

An infective propagule of C. perniciosa, is basidiospores which is produced in small mushroom-like basidiocarps. The basidiospores develop on brooms and diseased pods during rainy periods. They are then spread by wind and, upon landing on water, germinate and infect susceptible tissues of cacao. Vegetative brooms develop after infection of terminal and auxiliary buds. On the other hand, cushion brooms which resemble vegetative brooms develop from infected flower cushions as well as star blooms (diseased flowers) and chirimoya-like (diseased) pods. While infection of older pods results in little or no damage to pod content, infected seeds in developing pods of up to 12 weeks old are destroyed to the detriment of cocoa beans. Losses from witches' broom can affect up to 90% of the yield. Controlling witches' broom in cacao plants requires knowledge of many factors including disease epidemiology, favorable climates for disease prorogation, availability of pathogen inoculums and susceptible host tissues, sources of inoculums, the number of vegetative flushes and agronomic knowledge of plantation. These requirements coupled with the varying economic conditions make management and control of the disease difficult. Typically the disease is controlled by phytosanitation (pruning of witches' broom diseased sections from the tree) and chemical treatment. Any pruning should be done during the dry season and consequently this method may not be as practical or effective.

Applying protective fungicidal chemicals to developing pods on 7-day cycles has been found be costly and ineffective. Indeed, it has been suggested that durable resistance offers that best management and control of witches' broom. Screening of germplasm and using the best resistant germplasm has been suggested as additional means for producing resistant planting stocks.

If the diseased portions are left on the trees during the rainy season, the brooms begin to sporulate at the upper canopies. As a result, a flow of infective spores will be carried over and infect the new flower and foliage resulting in additional infections. During the following season the newly infected brooms will not produce spores and are a complete loss of the normal pod production. Although pruning the young infected trees can reduce the spreading, because of labor costs brooms are generally not removed. During the following rainy season the brooms will sporulate and cause further dispersal of the fungi. In addition, when the brooms are pruned they are often left on the ground area near the trees thereby providing a source for sporulation during the following rainy season.

It has been suggested that petroleum oil, such as those used for Sigatoka on banana, can be used to spray the old pruned brooms if it is applied prior to the start of the rainy season. Although petroleum oil is not a fungicide, it has been postulated that it provides a physical separator layer that stops absorption of rain water into the broom surfaces. Since the moisture within the infected brooms is considered to produce the basidiocarps for spore dispersal, the application of petroleum oil may reduce the spread. It should be noted however that the petroleum oil cannot be applied to new maturing cocoa pods, but only to the under story ground areas.

Thus, conventional means for controlling witches' broom include (i) keeping the trees short so that field crews can effectively locate and remove infected brooms; (ii) frequent pruning (every 10-14 days) to remove brooms and other infected material; (iii) removing pruned wood left on the grounds to avoid sporulation; and (iv) spraying the pruned brooms with petroleum oil to render the surfaces water-repellant.

These and other conventional methods have been found to be ineffective, costly and labor intensive. Thus, there is a need for chemical compositions and methods that can effective inhibit and/or eradicate witches' broom from trees in general and from cocoa trees in particular.

### DETAILED DESCRIPTION OF THE INVENTION

These and other needs can be addressed by applying a composition according to the principles of the invention to a tree or a plant afflicted with witches' broom. Accordingly, the embodiments of Applicants' invention are directed to compositions and methods for treating witches' broom in general and for treating witches' broom in cacao plants and mango trees in particular. Applicants have discovered that the synergistic effects of the constituents enumerated herein act in unison to substantially irradiate and inhibit the growth of witches' broom. The compositions described in the various embodiments of the invention can be directly applied or sprayed on the afflicted branches.

In one embodiment, the treatment includes applying an affective amount of a composition having an effective amount of a chloronitrile compound, a germicide, and a carrier. The germicide can be selected from the group consisting of diquat bromide, trichloromelamine, cetylpyridinium chloride, chloramines-T and trichloromelamine. In addition, the chloronitrile compound can be chlorothalonil. In another embodiment, the invention is directed to a fungicide for eradicating or inhibiting witches' broom with a composition prepared by forming a mixture of a chloronitrile compound and a germicide; preparing a solution of urea in water and dissolving the mixture in the carrier solution to form the antimicrobial composition.

More particularly, an embodiment of the invention is directed to a composition comprising an organochlorine fungicide, a herbicide, and a carrier. The fungicide and herbicide can be mixed to form a solid mixture and then dissolved in a solution of urea and water to form a spray solution for treating witches' broom in trees. The carrier can be any conventional carrier, though a preferred carrier comprises a solution of urea and water.

The organochlorine fingicide can include any one or a combination of conventional chloronitrile. In one embodiment, the organochlorine fungicide is chlorothalonil. Additionally, fungicides including chloramines (NH₂Cl), trichloromelamine (bactericide) or chlorendic anhydride can be substituted in place of (or in addition to) chlorothalonil.

The herbicide can include any one or a combination of conventional herbicides. An exemplary herbicide is diquat bromide which has been conventionally known as a weed killer. Diquat (6,7-dihydrodipyrido-pyrazidinium) is a yellow crystal soluble in water. Other quaternary herbicides can include commercial products such as Avenge, Diquat and Paraquat.

The addition of one or more surfactants has been found to be particularly useful to enhance adhesion and penetration of the composition onto the surfaces being treated. The synergistic presence of the surfactants enables adequate penetration of the active composition within the witches' broom figs to destroy the afflicted cells. An exemplary surfactant is sold under the trade name TRITON X-100 which is identified as a non-ionic surfactant of the class octylphenol ethoxylate. TRITON X-100 is a suitable surfactant because, it is capable of providing the desired surface tension properties while being non-toxic to trees and humans. Another exemplary class of surfactants includes capped hydroxyethylamides which is both nonionic and nontoxic. The latter class is sold under the trade name PROMIDIUM™ (supplied by Uniqema.) A third class of exemplary surfactants is polyoxyethylene phenol, which is both non-ionic and non toxic. These type of surfactants are commonly sold under the trade name IGEPALT™.

The amount of surfactant in the composition can be varied depending on the desired application without departing from the spirit of the invention. While the amount of surfactant used is typically a function of the particular composition, an amount of about 0.001-10% by weight or volume of the composition can comprise one or more surfactant. In one embodiment of the invention, the surfactant is added in an amount of about 0.01 to 3 wt. %.

In another embodiment, a composition according to the principles of the invention comprises chlorothalonil, diquat bromide, urea and water. Chlorothalonil and diquat bromide can be admixed in a ratio of about 70:30 (wt. %) to form a mixture. Urea and water can be combined in a ratio of about 20:80 (wt. %) to form a solution. Then a quantity of the first mixture can be dissolved in the solution at a ratio of about 0.05 ounces to one gallon of the carrier to form a composition according to one embodiment of the invention. In another embodiment, 40-90 wt. % (60-80 wt. %) of chlorothalonil is admixed with 60-10 wt. % (40-20 wt. %) diquat bromide to form a mixture. Then a solution is formed comprising 10-40 wt. % (10-30 wt. %) urea and 90-60 wt. % (90-70 wt. %) water to form a carrier solution. By combining about 0.02-1.0 ounces of the mixture with about 0.5-1.5 gallon, and preferably one gallon of the carrier solution, a composition according to an embodiment of the invention is formed.

In another embodiment, the composition of the invention includes chlorothalonil, trichloromelamine, urea and water. To form a composition according to this embodiment, chlorothalonil is admixed with trichloromelamine in a ratio of about 95:5 wt. % to form a mixture. About 0.05 ounces of this mixture is then dissolved in a 20:80 wt. % solution of urea in water to form a composition according to this embodiment of the invention. The ratios provided herein can be varied to more particularly formulate a solution for treating witches' broom. For example, about 0.2-2.0 ounces of a mixture of about 80-98 wt. % (90-98 wt. %) of chlorothalonil and 20-2 wt. % (10-2 wt. %) trichloromelamine can be dissolved in a solution of urea and water (10-40 wt. % urea and the balance water) to form a composition according an embodiment of the invention.

In still another embodiment, a composition of the invention includes cetylpyridinium chloride (or a similar quaternary ammonium salt) chlorothalonil, urea and water. To form a composition according to this embodiment, cetylpyridinium chloride is admixed with chlorothalonil in a ratio of about 10:90 wt. % to form a mixture. The mixture is then dissolved in urea and water in a ratio of about 1:19:80 (by weight) to form the desired composition. A similar formulation can be prepared by forming an admixture containing 5-30 wt. % (5-20 wt. %) of cetylpyridinium chloride with a balance of chlorothalonil to form an admixture and then dissolving about 0.05-2 wt. % of the admixture in 20 wt. % urea and 80 wt. % water.

In yet another embodiment, a composition of the invention includes chlorendic anhydride, chlorothalonil, urea and water. To form this composition, chlorendic anhydride and chlorothalonil are admixed in a ratio of about 0.5-5: 99.95-95 wt. % to form a mixture. The mixture is then dissolved in urea and water at a ratio of about 0.05-5:12-20: 80 (wt. %) to form the desired composition. A similar formulation can be prepared by forming an admixture containing 0.5-1.5 wt. % of chlorendinc anhydride with 99.5-98.5 wt. % chlorothalonil and then dissolving about 0.05-2 wt. % of the admixture in 20 wt. % urea and 80 wt. % water.

In still another embodiment, a composition of the invention includes chloramine-T (sodium P-toluenesulfochloramine), chlorothalonil, urea and water. To form this composition, chloramine-T and chlorothalonil are admixed in a ratio of about 5:95 wt. % to form a mixture. The mixture is then dissolved in urea and water in a ratio of about 0.05-5: 12-29: 80 (wt. %) to form the desired composition. A similar formulation can be prepared by forming an admixture containing 1-10 wt. % of chloramines-T with 99-90 wt% chlorothalonil to form an admixture and then dissolving about 0.05-2 wt. % of the admixture in about 20 wt. % urea and 80 wt. % water.

In yet another embodiment, a composition of the invention includes chlorothalonil, urea and water. To form this composition, chlorothalonil is dissolved in urea and water in a weight ratio of about 1:19:80 to create a fungicidal solution. A similar formulation can be prepared by dissolving 0.05-2 wt. % chlorothalonil in 20 wt. % urea and 80 wt. % water.

In still another embodiment, a composition of the invention includes chloramine-T, urea and water. To form this composition, chloramine-T is dissolved in urea and water in a weight ratio of about 1:19:80 to create a fungicidal solution. A similar formulation can be prepared by dissolving 0.05-2 wt. % chloramine-T in 20 wt. % urea and 80 wt. % water.

In yet another embodiment, a composition of the invention includes trichloromelamine dissolved in a carrier. To form this composition, trichloromelamine is dissolved in a solution of urea and water in a weight ratio of about 1:19:80 (wt. %) to create a fungicidal solution. A similar formulation can be prepared by dissolving 0.05-2 wt. % trichloromelamine in 20 wt. % urea and 80 wt. % water.

Although the ratios given herein are described in terms of weight percentage, the invention is not limited thereto and similar ratios, for example ratio based on volume, can be used without departing from the spirit of the invention.

Further, although the inventive embodiments described herein include specific compositions, it will be apparent to one of ordinary skill in the art that the principles of the invention can be extended to include a particular composition or a combination of elements not specifically recited herein and still be within the scope of this invention.

What is claimed is:

1. An antimicrobial composition comprising an effective amount of a chloronitrile compound, a germicide, urea and water.

2. The composition of claim 1, wherein the germicide is selected from the group consisting of diquat bromide, trichloromelamine, cetylpyridinium chloride, chloramines-T and trichloromelamine.

3. The composition of claim 1, wherein the chloronitrile compound is chlorothalonil.

4. The composition of claim 1, wherein the germicide is a bactericide.

5. The composition of claim 1, wherein the germicide is a herbicide.

6. The composition of claim 1, wherein the germicide is antimicrobial.

7. An antimicrobial composition consisting essentially of chlorothalonil, urea and water.

8. An antimicrobial composition consisting essentially of chloramine, urea and water.

9. An antimicrobial composition consisting essentially of trichloromelamine, urea and water.

10. An antimicrobial composition consisting essentially of chlorendic anhydride, chlorothalonil, urea and water.

11. A composition for preventing or retarding microbial growth in a plant, the composition produced by a process comprising:
providing a mixture of a chloronitrile compound and a germicide;
providing a solution of urea in water; and
dissolving the mixture in the solution to form the antimicrobial composition.

12. The antimicrobial composition of claim 11, wherein the chloronitrile compound is chlorothalonil.

13. The antimicrobial composition of claim 11, wherein the first mixture includes about 40-90 wt. % chlorothalonil and 60-10 wt. % diquat.

14. The antimicrobial composition of claim 11, wherein the mixture includes about 70 wt. % chlorothalonil and 30 wt. % diquat.

15. The antimicrobial composition of claim 11, wherein the solution further comprises about 10-40 wt. % urea and 90-60 wt. % water.

16. The antimicrobial composition of claim 11, wherein the solution further comprises about 20 wt. % urea and 80 wt % water.

17. The antimicrobial composition of claim 11, wherein the antimicrobial composition comprises about 0.02-1.0 ounces of the mixture and about one gallon of the solution.

18. The antimicrobial composition of claim 11, wherein the antimicrobial composition comprises about 0.05 ounces of the mixture and about one gallon of the mixture.

19. The antimicrobial composition of claim 11, wherein the germicide is a bactericide.

20. The antimicrobial composition of claim 11, wherein the germicide is selected from the group consisting of diquat bromide, trichloromelamine, cetylpyridinium chloride, chloramines-T and trichloromelamine.

21. An antimicrobial composition for preventing or retarding microbial growth in a plant, the composition produced by a process comprising:
providing a first mixture of chlorothalonil and a bactericide;
providing a second mixture of urea dissolved in water; and
substantially dissolving the first mixture in the second mixture to form the antimicrobial composition.

22. The antimicrobial composition of claim 21, wherein the bactericide is trichloromelamine.

23. The antimicrobial composition of claim 21, wherein the step of providing the first mixture further comprises admixing about 80-98 wt. % of the chlorothalonil with 20-2 wt. % of the bactericide.

24. The antimicrobial composition of claim 21, wherein the step of providing the first mixture further comprises admixing the chlorothalonil and the bactericide in a weight ratio of 95:5.

25. The antimicrobial composition of claim 21, wherein the step of providing the first mixture further comprises dissolving 10-40 wt % of the urea in 90-60 wt % of water.

26. The antimicrobial composition of claim 21, wherein the step of providing the second mixture comprises dissolving urea in water in a weight ration of 20:80.

27. The antimicrobial composition of claim 21, wherein the step of combining the first mixture with the second mixture further comprises dissolving about 0.02-2.0 ounces of the first mixture in about one gallon of the second mixture.

28. The antimicrobial composition of claim 21, wherein the step of combining the first mixture with the second mixture further comprises dissolving about 0.05 ounces of the first mixture in about one gallon of the second mixture.

29. An antimicrobial composition for treating Witches' Broom disorder in plants, the composition prepared by a process comprising:
providing a mixture of cetylpyridinium chloride and chlorothalonil;
forming the antimicrobial composition by dissolving the mixture in urea and water.

30. The antimicrobial composition of claim 29, wherein the mixture includes about 5-30 wt % of cetylpyridinium chloride and a balance of chlorothalonil.

31. The antimicrobial composition of claim 29, wherein the weight ratio of cetylpyridinium to chlorothalonil in the mixture is about 10:90.

32. The antimicrobial composition of claim 29, wherein the weight ratio of mixture:urea:eater is in the range of 0.05-2:19.95-18:80.

33. The antimicrobial composition of claim 29, wherein the ratio of the mixture:urea:water is about 1:19:80.

34. An antimicrobial composition for preventing or inhibiting witches' broom disorder in plants, the composition produced by a process comprising:
forming a first mixture by admixing a chlorendic anhydride with chlorothalonil in the weight a ratio of about 0.05-5:99.95-95; and
dissolving the first mixture and urea in water in a weight ratio of about 0.5-2:19.95-18:80 to form the antimicrobial composition.

35. The antimicrobial composition of claim 34, wherein the weight ratio of chlorendic anhydride to chlorothalonil is about 1:99.

36. The antimicrobial composition of claim 34, wherein the ratio of the first mixture:urea:water is about 1:19:80.

37. An antimicrobial composition prepared by a process comprising:
providing a first mixture of chloramines-T and chlorothalonil in a weight ratio of about 1-10:99-90; and
dissolving the first mixture and a quantity of urea in water in a weight ratio of about 0.05-2:19.95-18:80 to form an antimicrobial composition.

38. The antimicrobial composition of claim 37, wherein the first mixture includes chloramines-T and chlorothalonil in the weight ratio of about 5:95.

39. The antimicrobial composition of claim 37, wherein the ratio of the first mixture:urea:water is about 1:19:80.

40. An antimicrobial composition prepared by a process comprising dissolving about 0.05-5 wt. % of chlorothalonil and about 12-20 wt % urea in about 80 wt % water to obtain the antimicrobial composition.

41. The antimicrobial composition of claim 40, wherein the weight ratio of chlorothalonil:urea:water is about 1:19:80.

42. An antimicrobial composition prepared by a process comprising dissolving about 0.05-5 wt. % of chloramine-T and about 12-29 wt % urea in about 80 wt % water to obtain the antimicrobial composition.

43. The antimicrobial composition of claim 42, wherein the weight ratio of chloramine-T :urea:water is about 1:19:80.

44. An antimicrobial composition prepared by a process comprising dissolving about 0.05-2 wt. % of trichloromelamine and about 19.95-18 wt % urea in about 80 wt % water to obtain the antimicrobial composition.

45. The antimicrobial composition of claim 44, wherein the weight ratio of trichloromelamine :urea:water is about 1:19:80.
